(19) United States
(12) Patent Application Publication
(10) Pub. No.: US 2015/0015666 A1
(43) Pub. Date: Jan. 15, 2015

(54) METHOD AND APPARATUS FOR PROVIDING 3D VIDEO STREAMING SERVICE

(71) Applicant: ELECTRONICS AND TELECOMMUNICATIONS RESEARCH INSTITUTE, Daejeon (KR)

(72) Inventors: Sun Hyoung KWON, Seoul (KR); Ho Kyom KIM, Daejeon (KR); Seok Ho WON, Daejeon (KR); Jong Soo LIM, Daejeon (KR); O Hyung KWON, Daejeon (KR)

(73) Assignee: ELECTRONICS AND TELECOMMUNICATIONS RESEARCH INSTITUTE, Daejeon (KR)

(21) Appl. No.: 14/078,737

(22) Filed: Nov. 13, 2013

(30) Foreign Application Priority Data
Jul. 9, 2013 (KR) 10-2013-0080594

(51) Int. Cl. H04N 13/00

(52) U.S. Cl. CPC H04N 13/0018; H04N 13/0022
USPC 348/43

(57) ABSTRACT

In order to provide a three-dimensional (3D) video streaming service to a user terminal, user characteristic information including eyesight information of the left eye and the right eye of a user is received from the user terminal. Then, one of quality of a left image and that of a right image is improved in accordance with the eyesight information so that an image with improved quality is transmitted to the user terminal.

### CROSS-REFERENCE TO RELATED APPLICATION

This application claims priority to and the benefit of Korean Patent Application No. 10-2013-0080594 filed in the Korean Intellectual Property Office on Jul. 9, 2013, the entire contents of which are incorporated herein by reference.

### BACKGROUND OF THE INVENTION

(a) Field of the Invention

The present invention relates to a method of providing a video streaming service. More particularly, the present invention relates to a method and an apparatus for providing a three-dimensional (3D) video streaming service.

(b) Description of the Related Art

Among methods of serving a three-dimensional (3D) video, currently, a stereoscopic method is widely used. In the stereoscopic method, two images, that is, a left image and a right image, are used to generate binocular disparity and to provide depth perception and stereoscopic perception to a subject. The stereoscopic method is supported by a frame-compatible format and a sequential format.

In the frame-compatible format designed for compatibility with an encoder and a decoder for a conventional two-dimensional (2D) video service, one screen is divided into two so that a left image and a right image are simultaneously arranged on the screen. On the other hand, in the sequential format, the left image and the right image independently exist so that there is no compatibility with the encoder and the decoder for the conventional 2D video service, however, full resolution may be supported.

In addition, for an optimal video streaming service, technologies of scalably controlling quality of the left image and that of the right image are provided. Specifically, quality of an image of one side is fixed and only quality of an image of the other side is scalably controlled, quality of the left image and that of the right image are symmetrically and scalably controlled in the same level, or quality of the left image and that of the right image may be freely, non-symmetrically, and scalably controlled.

In the conventional 3D video streaming service, the quality of the left image and that of the right image may be scalably controlled. However, a service that considers characteristics of respective users is not provided. Eyesight of the left eye and that of the right eye are commonly different from each other. That is, although left and right images with the same quality are provided to a user, the user receives the left and right images with the quality of the left image and that of the right image distorted by eyesight of the left eye and that of the right eye. Therefore, it is necessary to provide an optimal video service for characteristics of respective users.

### SUMMARY OF THE INVENTION

A technical object of the present invention is to provide a method and an apparatus for providing a three-dimensional (3D) video streaming service in consideration of characteristics of respective users.

According to one aspect of the present invention, a method of providing a three-dimensional (3D) video streaming service to a user terminal includes receiving user characteristic information including eyesight information of a left eye and a right eye of a user from the user terminal and improving one of quality of a left image and that of a right image in accordance with the eyesight information to provide an image with improved quality to the user terminal.

Improving one of quality of the left image and that of the right image in accordance with the eyesight information to provide an image with the improved quality to the user terminal may include increasing a data rate of a first image corresponding to the eye determined to have better eyesight in accordance with the eyesight information to transmit the first image. In this case, the data rate of the first image may be increased so that a difference between a peak signal-to-noise ratio (PSNR) of the first image and that of a second image corresponding to the eye determined to have worse eyesight in accordance with the eyesight information is within a predetermined value.

In addition, improving one of quality of the left image and that of the right image in accordance with the eyesight information to provide an image with the improved quality to the user terminal may further include increasing the data rate of the first image to transmit the first image, and then increasing a data rate of the second image corresponding to the eye determined to have worse eyesight in accordance with the eyesight information to transmit the second image.

Improving one of quality of the left image and that of the right image in accordance with the eyesight information to provide an image with the improved quality to the user terminal may further include processing the left image and the right image in a first format structure where the left image and the right image are arranged on one screen to transmit the processed images, and transmitting the left image and the right image in a second format structure where one of quality of the left image and that of the right image is improved in accordance with the eyesight information and an image corresponding to the eye having better eyesight between the left image and the right image is first transmitted.

In this case, improving one of quality of the left image and that of the right image in accordance with the eyesight information to provide an image with the improved quality to the user terminal may further include checking a network bandwidth, and in transmitting the left image and the right image in the second format structure, when the network bandwidth has available bandwidth of no less than a predetermined bandwidth, the left image and the right image may be transmitted in the second format structure.

In addition, the user characteristic information may include information that represents only which eyesight of the user is better. In this case, the user characteristic information may be two-bit information, eyesight of the left eye of the user may be similar to that of the right eye of the user with a difference within a predetermined value when the user characteristic information is “11”, eyesight of the left eye of the user may be better than that of the right eye of the user when the user characteristic information is “10”, and eyesight of the right eye of the user may be better than that of the left eye of the user when the user characteristic information is “01”.

According to another aspect of the present invention, an apparatus for providing a three-dimensional (3D) video streaming service to a user terminal includes a user characteristic information obtaining unit for receiving user characteristic information including eyesight information of a left eye and a right eye of a user from the user terminal, a left image processing unit for generating a left image corresponding to the left eye of the user and controlling quality of the left image in order to provide 3D content, a right image processing unit for generating a right image corresponding to the right eye of the user and controlling quality of the right image in order to provide 3D content, and an image transmitting unit for processing the left image and the right image in a first format structure or a second format structure to transmit the processed images to the user terminal. Quality of an image corresponding to the eye determined to have better eyesight in accordance with the user characteristic information between the left image and the right image is controlled to be better.

The image transmitting unit may process the left image and the right image in a first format structure where the left image and the right image are arranged on one screen to transmit the processed images, and may transmit the left image and the right image in a second format structure where an image with quality improved to correspond to the eye determined to have better eyesight in accordance with the eyesight information between the left image and the right image is first transmitted.

The apparatus may further include a network bandwidth sensing unit for sensing a network bandwidth. The image transmitting unit may transmit the left image and the right image in the second format structure when it is determined that the network bandwidth has available bandwidth of no less than a predetermined bandwidth based on the sensing result of the network bandwidth sensing unit.

In addition, a data rate of a first image may be increased so that a difference between a peak signal-to-noise ratio (PSNR) of the first image corresponding to the eye determined to have better eyesight in accordance with the eyesight information and that of a second image corresponding to the eye determined to have worse eyesight in accordance with the eyesight information is within a predetermined value.

### BRIEF DESCRIPTION OF THE DRAWINGS

FIG. 1 illustrates a network environment that provides a three-dimensional (3D) video streaming service according to an exemplary embodiment of the present invention.

FIG. 2 is an exemplary view illustrating a structure of an image for a 3D video streaming service according to an exemplary embodiment of the present invention.

FIG. 3 is a view illustrating a structure of an apparatus for providing a 3D video streaming service according to an exemplary embodiment of the present invention.

FIG. 4 is a flowchart of a method of providing a 3D video streaming service according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

In the entire specification and claims, unless explicitly described to the contrary, the word “comprise” and variations such as “comprises” or “comprising” will be understood to imply the inclusion of stated elements but not the exclusion of any other elements.

Hereinafter, a method and an apparatus for providing a three-dimensional (3D) video streaming service according to an exemplary embodiment of the present invention will be described.

Eyesight of the left eye and that of the right eye are commonly different from each other. The above means that recognition quality of the left eye is different from that of the right eye due to a difference between eyesight of the left eye and that of the right eye of a person who recognizes an image. That is, although left and right images with the same quality are provided to a user, the user receives the left and right images with the quality of the left image and that of the right image distorted by eyesight of the left eye and that of the right eye.

According to the exemplary embodiment of the present invention, a 3D video streaming service is provided using characteristics of respective users, particularly, a difference between eyesight of the left eye and that of the right eye of each of the users.

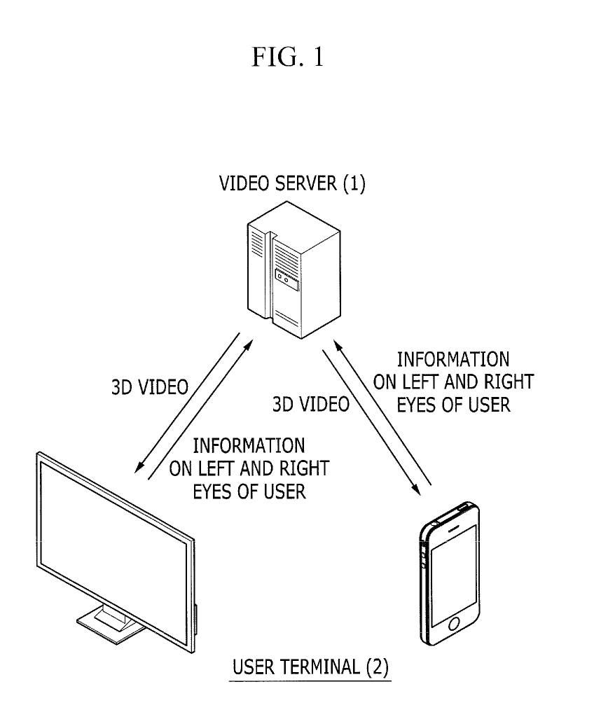

FIG. 1 illustrates a network environment that provides a 3D video streaming service according to an exemplary embodiment of the present invention.

As illustrated in FIG. 1, a video server 1 provides 3D content to a user. The video server 1 provides the 3D content to terminals 2 of the user such as a smart TV and a smart phone.

According to the exemplary embodiment of the present invention, the user terminal 2 transmits characteristic information of a user to the video server 1 and the video server 1 provides the 3D content with quality suitable for a state of the user in consideration of the user characteristic information. The user terminal 2 provides the user characteristic information, that is, characteristic information including eyesight of the left eye (left eyesight) of the user and that of the right eye (right eyesight) of the user to the video server 1.

The video server 1 controls quality of the 3D content in consideration of the user characteristic information.

According to the exemplary embodiment of the present invention, the user characteristic information may be divided into three types. These include, first, a case in which the left eyesight of the user is similar to the right eyesight of the user, second, a case in which the left eyesight of the user is better than the right eyesight of the user, and third, a case in which the right eyesight of the user is better than the left eyesight of the user. The user terminal 2 may transmit characteristic information that represents only which eyesight is better to the video server 1 or may transmit characteristic information including detailed eyesight information to the video server 1. The user terminal 2 may process the characteristic information that represents which eyesight is higher into two-bit information to transmit the processed information as follows.

TABLE 1

| Characteristic | |
|---|---|
| information | Remarks |
| 11 | Left eyesight is similar to right eyesight with |
| | a difference within a predetermined value |
| 10 | Left eyesight is better than right eyesight |
| 01 | Right eyesight is better than left eyesight |

The user terminal 2 may obtain information on the left eyesight and the right eyesight of the user through various methods. For example, the information on the left eyesight and the right eyesight of the user may be directly received from the user through an interface apparatus (a keyboard or a touch screen), or may be obtained using an application that performs a simple test of confirming states of the eyes of the user. Furthermore, in the future, the information on the left eyesight and the right eyesight of the user may be obtained by monitoring the user's health using a smart device.

According to the exemplary embodiment of the present invention, quality of an image is controlled based on the user characteristic information received from the user terminal. Quality of a left image and that of a right image are sequentially improved from an image of a side where eyesight is determined to be better based on the user eyesight information included in the user characteristic information. To be specific, when the left eyesight is better than the right eyesight with a difference of no less than a predetermined value, the quality of the left image is gradually improved and then that of the right image is improved. When the right eyesight is better than the left eyesight with a difference of no less than a predetermined value, the quality of the right image is gradually improved and then that of the left image is improved. In this case, quality of an image may be controlled in consideration of a radio resource state. Quality of an image of one side may be controlled by a scalable video coding (SVC) method. However, according to the present invention, a method of controlling quality of an image is not limited to the SVC, and any video codec that may scalably control image quality may be used.

According to the exemplary embodiment of the present invention, in order to provide the 3D content by the stereoscopic method, the video server 1 provides the video streaming service using the left image and the right image.

When the left image and the right image are recognized, in a case where a peak signal-to-noise ratio (PSNR) of the left image is not remarkably different from that of the right image, the user recognizes an entire image with quality of the image having a larger PSNR. According to the exemplary embodiment of the present invention, the quality of the left image and that of the right image are sequentially improved from the image of the side where eyesight of the user is determined to be better based on the user eyesight information included in the user characteristic information so that the user may recognize the entire image with higher quality corresponding to the eye having better eyesight.

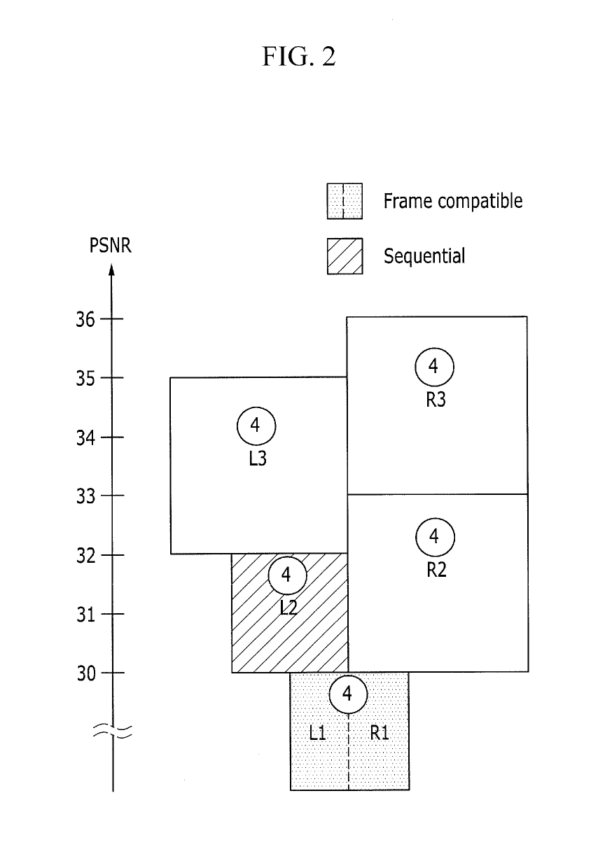

FIG. 2 is an exemplary view illustrating a structure of an image for a 3D video streaming service according to an exemplary embodiment of the present invention. Here, the left eyesight of a user is determined to be better than the right eyesight of the user in accordance with user characteristic information so that a left image has priority over a right image.

For a scalable 3D video streaming service, an image is configured by a frame-compatible format or a sequential format. In the frame-compatible format, one screen is divided into two so that the left image and the right image are simultaneously arranged on the screen. In the sequential format, each of the left image and the right image is arranged on one screen. According to the exemplary embodiment of the present invention, an image is configured by both the frame-compatible format and the sequential format to be provided to a user terminal.

As illustrated in FIG. 2, priorities may be provided to respective provided images. When there are a plurality of left image L1 to L3 and a plurality of right image R1 to R3, it is assumed that the respective images are provided with priorities in the order of numbers in circles. In addition, since the left eyesight of the user is better than the right eyesight of the user, it is assumed that the left image has priority over the right image.

In addition, when images are provided in the sequential format, it is assumed that amounts of data items of the respective images are proportional to areas of corresponding quadrangles illustrated in FIG. 2. That is, it is assumed that an amount of data of the image L2 is smaller than that of the image L3, and the image L3, the image R2, and the image R3 have the same amount of data. The above means that, based on a PSNR of an image, as illustrated in FIG. 2, an amount of data required for increasing quality of the image from 30 dB to 33 dB is the same as that required for increasing quality of the image from 33 dB to 36 dB.

First, in order to provide a stable 3D image to a user, an image with the lowest quality is configured by the frame-compatible format having high compatibility with a two-dimensional (2D) encoder and decoder. When the image with the lowest quality is divided into a left image and a right image to be encoded, only the left image or the right image may be received. When only one image is received, a 2D image in which the user may not perceive depth perception is received so that a 3D image may not be provided. In this case, since consistency of a service of continuously providing 3D content is deteriorated, the image with the lowest quality must be configured by the frame-compatible format in which the left image and the right image are simultaneously arranged in one frame.

Next, when a network bandwidth is sufficient, images configured by the sequential format are provided. In the images configured by the sequential format, the images are sequentially transmitted from an image with lower priority. Here, the left images L1 and L2 may be designed to have dependency and may be designed to not have dependency in order to reduce complexity. The left images L2 and L3 may be designed to have dependency when the SVC codec is used, and may be designed to not have dependency when a multiple description coding (MDC) codec is used. The right images may be designed like the left images.

When the images are provided in the structure illustrated in FIG. 2, in a case where only an image with a priority number 1 is provided, the user may recognize a 3D image by the left image L1 and the right image R1 with quality corresponding to the PSNR of 30 dB.

When images with priority numbers 1 and 2 are provided, that is, when the left image L1 and the right image R1 with the quality corresponding to the PSNR of 30 dB are arranged on one screen to be provided in accordance with the frame-compatible format and the quality of the left image corresponding to the left eye determined to have better eyesight in accordance with the user characteristic information is improved so that the left image L2 with quality corresponding to a PSNR of 32 dB is provided, the PSNR of the left image L2 is 32 dB and the PSNR of the right image R1 is 30 dB. A difference between the PSNR of the left image and that of the right image is about 2 dB. In the above difference in the PSNR, an image is recognized with the quality corresponding to the PSNR of the image with higher quality so that 3D image quality that the user perceives is 32 dB.

When images corresponding to priority numbers 1, 2, and 3 are provided, that is, when the left image L1 and the right image R1 with the quality corresponding to the PSNR of 30 dB are arranged on one screen to be provided in accordance with the frame-compatible format and the quality of the left image corresponding to the left eye determined to have better eyesight in accordance with the user characteristic information is improved so that the left image L2 with the quality corresponding to the PSNR of 32 dB is provided and the independently generated right image R2 with quality corresponding to a PSNR of 33 dB is provided, the PSNR of the left image is 32 dB and the PSNR of the right image is 33 dB. An image is recognized with the quality corresponding to the PSNR of the image with higher quality so that 3D image quality that the user feels is 33 dB. When images with higher quality are provided, a 3D image is realized by a similar principle.

When some or all of five images consisting of the segments illustrated in FIG. 2 are provided, 3D quality that the user perceives may be as illustrated in Table 2 as follows.

TABLE 2

| | | | | | | | Recognition |
|---|---|---|---|---|---|---|---|
| | | | | | Left image | Right image | quality |
| 1 | 2 | 3 | 4 | 5 | quality | quality | of a user |
| ◯ | | | | | 30 dB | 30 dB | 30 dB |
| ◯ | ◯ | | | | 32 dB | 30 dB | 32 dB |
| ◯ | | ◯ | | | 30 dB | 33 dB | 33 dB |
| ◯ | ◯ | ◯ | | | 32 dB | 33 dB | 33 dB |
| ◯ | ◯ | | ◯ | | 35 dB | 30 dB | imbalance |
| ◯ | | ◯ | | ◯ | 30 dB | 36 dB | imbalance |
| ◯ | ◯ | ◯ | ◯ | | 35 dB | 33 dB | 35 dB |
| ◯ | ◯ | ◯ | | ◯ | 32 dB | 36 dB | imbalance |
| ◯ | ◯ | ◯ | ◯ | ◯ | 35 dB | 36 dB | 36 dB |

Here, it is assumed that the left image and the right image configured by the sequential format are processed by the SVC codec. Actually, other than the SVC codec, the MDC codec or any codec that supports a function of controlling image quality (a scalable function) may be used and the 3D image quality that the user perceives as illustrated in Table 2 may vary with a codec used. Here, Table 1 is suggested as an example for a case in which the SVC codec is used.

According to the exemplary embodiment of the present invention, based on the fact that, when a difference between quality of the left image and that of the right image is not large, an image is recognized with higher quality between quality of the left image and that of the right image, and it is assumed that, when a difference between the PSNR of the left image and that of the right image is no more than a predetermined value (e.g., 3 dB), the user recognizes an image with higher quality. That is, when the difference between the quality of the left image and that of the right image is smaller than the predetermined value, 3 dB, an image is recognized with higher quality between quality of the left image and that of the right image, and when the difference between the quality of the left image and that of the right image is larger than the predetermine value, 3 dB, imbalance between the left image and the right image is caused so that satisfaction of the user is deteriorated. In the Table 2, “◯” means that the corresponding image is normally supported.

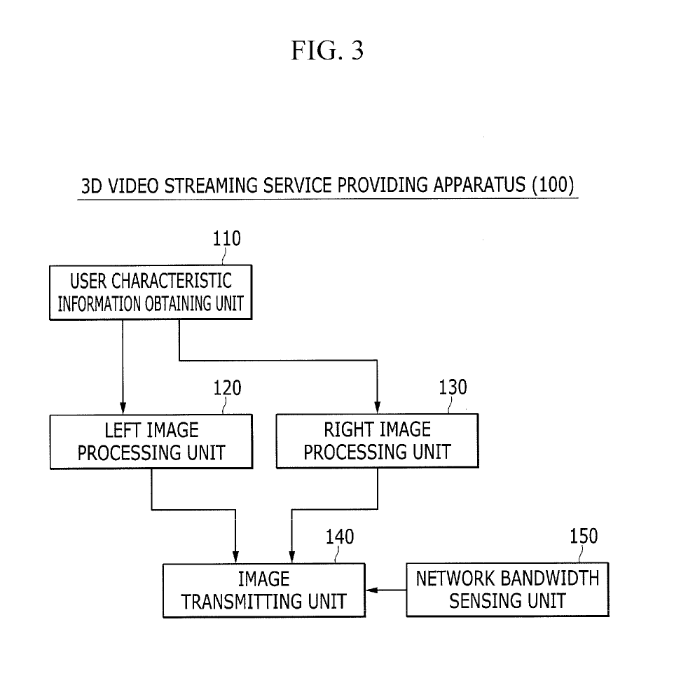

FIG. 3 is a view illustrating a structure of an apparatus for providing a 3D video streaming service according to an exemplary embodiment of the present invention.

As illustrated in FIG. 3, a 3D video streaming service providing apparatus 100 according to the exemplary embodiment of the present invention includes a user characteristic information obtaining unit 110, a left image processing unit 120, a right image processing unit 130, and an image transmitting unit 140. At least one among the units 110-140 may be included in a processor.

The user characteristic information obtaining unit 110 receives user characteristic information from the user terminal 2 that is to receive a 3D video streaming service. The user characteristic information includes information on the left eyesight and the right eyesight of a user, and may have a structure illustrated in Table 1.

The left image processing unit 120 generates a left image of a provided image and controls quality of the left image in order to provide 3D content. The right image processing unit 130 generates a right image of a provided image and controls quality of the right image in order to provide 3D content. Particularly, the left image processing unit 120 and the right image processing unit 130 controls the quality of the left image or that of the right image based on the user characteristic information.

For example, when it is determined that a difference between the left eyesight and the right eyesight is no less than predetermine eyesight in accordance with the user characteristic information, quality of an image corresponding to the eye having better eyesight between the left eyesight and the right eyesight of the user is improved. That is, an amount of data of an image may be increased.

When it is determined that the left eyesight of the user is better than the right eyesight of the user with a difference of no less than predetermined eyesight, the left image processing unit 120 improves quality of the generated left image so that the quality of the left image is no less than predetermined quality and provides the left image with the improved quality to the image transmitting unit 140. In addition, when it is determined that the right eyesight of the user is better than the left eyesight of the user with a difference of no less than predetermined eyesight, the right image processing unit 130 improves quality of the generated right image so that the quality of the right image is no less than predetermined quality and provides the right image with the improved quality to the image transmitting unit 140. Here, the predetermined quality may be in a range where imbalance between the left image and the right image is not caused so that satisfaction of the user is not deteriorated. For example, as illustrated in the Table 2, the predetermined quality may be set so that the difference between the PSNR of the left image and that of the right image is about 3 dB.

The image transmitting unit 140 transmits the left image and the right image to the user terminal 2. The image transmitting unit 140 processes the left image and the right image in a first format structure or a second format structure to transmit the processed images to the user terminal 2. Here, the first format structure may be the frame-compatible format and the second format structure may be the sequential format. The image transmitting unit 140 first processes the left image and the right image in the first format structure to transmit the processed images, and then processes the left image and the right image in the second format structure to transmit the processed images. In the second format structure, quality of an image corresponding to better eyesight is first improved so that the image with the improved quality is provided, and then quality of the remaining image is improved so that the image with the improved quality is provided.

The image transmitting unit 140 may change a structure of an image from the first format structure to the second format structure in accordance with a network bandwidth so that the 3D video streaming service providing apparatus 100 may further include a network bandwidth sensing unit 150 for sensing a network bandwidth.

The above-structured 3D video streaming service providing apparatus 100 may be realized in the form included in the video server 1.

Next, a method of providing a 3D video streaming service according to an exemplary embodiment of the present invention will be described based on the above structure.

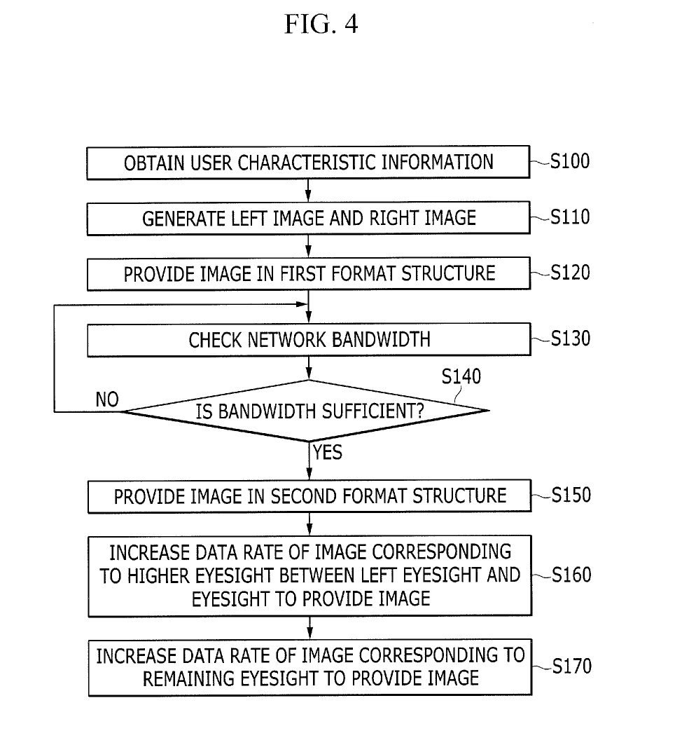

FIG. 4 is a flowchart of a method of providing a 3D video streaming service according to an exemplary embodiment of the present invention.

The 3D video streaming service providing apparatus 100 according to the exemplary embodiment of the present invention positioned in the video server 1 receives the user characteristic information from the user terminal 2 in the network environment illustrated in FIG. 1 (S100). The user characteristic information may represent which is better between the left eyesight and the right eyesight of a user, or may include information on the left eyesight and the right eyesight of the user.

The 3D video streaming service providing apparatus 100 generates the left image and the right image for the 3D video streaming service (S110). Here, the generated left and right images may be configured by the same amount of data, that is, a first data rate.

While providing the 3D video streaming service to the user terminal, the 3D video streaming service providing apparatus 100 processes the left image and the right image in the first format structure to transmit the processed images to the user terminal 2 (S120). As illustrated in FIG. 2, an image is transmitted in the format where the left image and the right image configured by the same data rate are simultaneously arranged on one screen.

Then, the 3D video streaming service providing apparatus 100 checks a network bandwidth (S130), and when the network bandwidth is sufficient, for example, when a non-used network bandwidth is no less than a predetermined bandwidth, changes a transmission format of an image into the second format structure (S140 and S150. Here, the transmission format structure is changed in accordance with the network bandwidth. However, the present invention is not limited to the above. For example, the transmission format structure may be changed regardless of the network bandwidth.

The 3D video streaming service providing apparatus 100 may select one of the left image and the right image in accordance with the second format structure to transmit the selected image. At this time, in accordance with the user characteristic information, quality of an image corresponding to better eyesight between the left eyesight and the right eyesight is first improved so that the image with the improved quality is provided, and then quality of an image with the remaining eyesight is improved so that the image with the improved quality is provided (S160 and S170). For example, as illustrated in FIG. 2, when the left eyesight is better than the right eyesight, the left image and the right image having the first data rate are simultaneously provided in the first format structure, and then the quality of the left image corresponding to better eyesight is improved by the second data rate that is larger than the first data rate and the left image with the improved quality is first provided in the second format structure. Then, the quality of the right image is improved by the second data rate so that the right image with the improved quality is provided. Here, the quality of the right image may be improved by a third data rate that is larger than the second data rate so that the right image with the improved quality may be provided.

On the other hand, the second data rate may be controlled so that a difference between the PSNR of the right image provided by the first data rate and that of the left image provided by the second data rate is within a predetermined value, for example, 3 dB.

By the above-described image transmission, in accordance with the user characteristic information, the quality of the left image corresponding to the left eye having better eyesight is improved so that the left image with the improved quality is provided. Therefore, due to the difference between the quality of the left image and that of the right image, the user recognizes an image with higher quality so that the 3D image quality that the user perceives is improved.

According to the exemplary embodiment of the present invention, quality of an image provided to the left eye and that of an image provided to the right eye may be controlled in accordance with eyesight of the left eye and that of the right eye of the user so that an amount of required data may be reduced while maintaining recognition quality of the user. That is, a limited resource may be efficiently used so that satisfaction of a 3D content user may be improved.

The exemplary embodiment of the present invention is not realized only by the above-described apparatus and/or method, but may also be realized by a program for realizing a function corresponding to a configuration of the exemplary embodiment of the present invention and a recording medium in which the program is recorded. Such realization may be easily performed by those skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of providing a three-dimensional (3D) video streaming service to a user terminal, comprising:
receiving user characteristic information including eyesight information of a left eye and a right eye of a user from the user terminal; and
improving one of quality of a left image and that of a right image in accordance with the eyesight information to provide an image with improved quality to the user terminal.

2. The method of claim 1, wherein improving one of quality of a left image and that of a right image in accordance with the eyesight information to provide an image with the improved quality to the user terminal comprises increasing a data rate of a first image corresponding to the eye determined to have better eyesight in accordance with the eyesight information to transmit the first image.

3. The method of claim 2, wherein the data rate of the first image is increased so that a difference between a peak signal-to-noise ratio (PSNR) of the first image and that of a second image corresponding to the eye determined to have worse eyesight in accordance with the eyesight information is within a predetermined value.

4. The method of claim 2, wherein improving one of quality of the left image and that of the right image in accordance with the eyesight information to provide an image with the improved quality to the user terminal further comprises increasing the data rate of the first image to transmit the first image, and then increasing a data rate of the second image corresponding to the eye determined to have worse eyesight in accordance with the eyesight information to transmit the second image.

5. The method of claim 1, wherein improving one of quality of the left image and that of the right image in accordance with the eyesight information to provide an image with the improved quality to the user terminal further comprises:
processing the left image and the right image in a first format structure where the left image and the right image are arranged on one screen to transmit the processed images; and
transmitting the left image and the right image in a second format structure where one of quality of the left image and that of the right image is improved in accordance with the eyesight information and an image corresponding to the eye having better eyesight between the left image and the right image is first transmitted.

6. The method of claim 5, wherein improving one of quality of the left image and that of the right image in accordance with the eyesight information to provide an image with the improved quality to the user terminal further comprises checking a network bandwidth,
wherein, in transmitting the left image and the right image in the second format structure, when the network bandwidth has available bandwidth of no less than a predetermined bandwidth, the left image and the right image are transmitted in the second format structure.

7. The method of claim 1, wherein the user characteristic information comprises information that represents only which eyesight of the user is better.

8. The method of claim 7,
wherein the user characteristic information is two-bit information,
when the user characteristic information is “11”, eyesight of the left eye of the user is similar to that of the right eye of the user with a difference within a predetermined value,
when the user characteristic information is “10”, eyesight of the left eye of the user is better than that of the right eye of the user, and
when the user characteristic information is “01”, eyesight of the right eye of the user is better than that of the left eye of the user.

9. An apparatus for providing a three-dimensional (3D) video streaming service to a user terminal, comprising:
a user characteristic information obtaining unit for receiving user characteristic information including eyesight information of the left eye and the right eye of a user from the user terminal;
a left image processing unit for generating a left image corresponding to the left eye of the user and controlling quality of the left image in order to provide 3D content;
a right image processing unit for generating a right image corresponding to the right eye of the user and controlling quality of the right image in order to provide 3D content; and
an image transmitting unit for processing the left image and the right image in a first format structure or a second format structure to transmit the processed images to the user terminal,
wherein quality of an image corresponding to the eye determined to have better eyesight in accordance with the user characteristic information between the left image and the right image is controlled to be better.

10. The apparatus of claim 9, wherein the image transmitting unit processes the left image and the right image in a first format structure where the left image and the right image are arranged on one screen to transmit the processed images and transmits the left image and the right image in a second format structure where an image with quality improved to correspond to the eye determined to have better eyesight in accordance with the eyesight information between the left image and the right image is first transmitted.

11. The apparatus of claim 10, further comprising a network bandwidth sensing unit for sensing a network bandwidth,
wherein the image transmitting unit transmits the left image and the right image in the second format structure when it is determined that the network bandwidth has available bandwidth of no less than a predetermined bandwidth based on the sensing result of the network bandwidth sensing unit.

12. The apparatus of claim 9, wherein a data rate of a first image is increased so that a difference between a peak signal-to-noise ratio (PSNR) of the first image corresponding to the eye determined to have better eyesight in accordance with the eyesight information and that of a second image corresponding to the eye determined to have worse eyesight in accordance with the eyesight information is within a predetermined value.
